(19) United States
(12) Patent Application Publication
(10) Pub. No.: US 2026/0334494 A1
(43) Pub. Date: Oct. 29, 2026

(54) CREAMER

(71) Applicant: SOCIÉTÉ DES PRODUITS NESTLÉ S.A., Vevey (CH)

(72) Inventors: Chrystel LORET, Lausanne (CH); Alice MOUGIN, Singapore (SG); Ying ZHENG, Dublin, OH (US); Jun-Tse Ray FU, Dublin, OH (US); Mahesh KHARAT, Dublin, OH (US)

(21) Appl. No.: 19/487,930

(22) PCT Filed: May 21, 2024
(86) PCT No.: PCT/EP2024/063901

§ 371 Date: Nov. 25, 2025

Related U.S. Application Data
(60) Provisional application No. 63/469,624, filed on May 30, 2023.

(30) Foreign Application Priority Data
Jul. 4, 2023 (EP) 23183179.3

(51) Int. Cl. A23C 11/10; A23L 25/00

(52) U.S. Cl. CPC A23C 11/103; A23L 25/30; A23L 25/40

(57) ABSTRACT

The present invention provides a creamer composition comprising ground flaxseed. The present invention also relates to a beverage capsule, a beverage system, and a beverage composition comprising the creamer composition. The present invention also relates to methods for producing the creamer composition.

### FIELD OF THE INVENTION

The present invention relates to clean label plant-based creamer compositions. The present invention also relates to beverage capsules, beverage systems, and beverage compositions comprising the creamer compositions. The present invention also relates to methods for producing the creamer compositions.

### BACKGROUND TO THE INVENTION

Creamers are widely used as whitening agents and texture/mouthfeel modifiers for hot and cold beverages, e.g., coffee, cocoa, tea, etc. They are commonly used as an alternative to milk or dairy cream. Creamers may come in a variety of different flavours and provide a whitening effect, mouthfeel, body, and a smoother texture, and may be in powdered or liquid form.

The creamer needs to be physically stable when added to foods and drinks made with water. For a creamer to perform well in a beverage, the creamer should be stable and free of aggregates or clumps when added to the beverage and until the beverage is completely consumed.

Consumers are increasingly demanding natural and nutritious food and beverages that also have a low carbon footprint. However, plant-based creamers currently on the market typically rely upon the use of emulsifiers, buffering agents, and/or hydrocolloids to retain stability.

Thus, there is a demand for clean label plant-based creamers with functional benefits.

### SUMMARY OF THE INVENTION

The present inventors have developed a creamer composition comprising ground flaxseed. The creamer composition has a homogeneous and stable texture, without phase separation and without use of additional stabilizers, and is rich in dietary fiber and omega 3 fat.

The present inventors have surprisingly found that by processing flaxseeds through wet milling (for example in a colloid mill), the natural oil body membrane encapsulating flaxseed fat is kept quasi-intact allowing a milling of whole flaxseed without fat oxidation, preventing coalescence and Ostwald ripening. This wet milling process also allows extraction of the soluble fibers helping the formation of a homogeneous suspension, which is not feasible with a dry-milling process.

The present inventors have surprisingly found that by processing flaxseeds through wet milling, the use of wet milling further removes or reduces the need for emulsifiers or buffer salts as it is not necessary to add other proteins to stabilise the creamer emulsion.

In one aspect, the present invention provides a creamer composition comprising ground flaxseed. The term “ground flaxseed” may refer to flaxseed which has undergone a size reduction process, for example grinding or milling.

Any suitable source of flaxseed may be used in the present invention, including any suitable flaxseed variety, whole or dehulled flaxseed, roasted flaxseed, and/or enzymatically treated flaxseed. Suitably, the flaxseed is a golden variety, such as a NuLin variety or an Omega variety. In some embodiments, the flaxseed is dehulled. In some embodiments, the flaxseed is roasted. In some embodiments, the flaxseed is enzymatically treated, such as enzymatically treated with cellulase and/or xylanase.

The ground flaxseed may be wet-milled, preferably using a colloid mill. The ground flaxseed may have any suitable particle size. Suitably, the ground flaxseed has a particle size D90 of about 800 μm or less, about 700 μm or less, about 600 μm or less, or about 500 μm or less. Suitably, the ground flaxseed has a particle size D(3,2) of about 20 μm or less, about 15 μm or less, about 10 μm or less, about 9 μm or less, about 8 μm or less, about 7 μm or less, about 6 μm or less, or about 5 μm or less.

The creamer composition may comprise the ground flaxseed in any suitable amount. Suitably, the creamer composition comprises the ground flaxseed in an amount of about 5 wt % or more.

The creamer composition of the present invention may comprise flaxseed oil, flaxseed protein, and flaxseed dietary fibre in any suitable amount. Suitably, the creamer composition comprises: (a) flaxseed oil in an amount of about 5 wt % or more and/or about 70 wt % or less, on a dry weight basis; (b) flaxseed dietary fiber in an amount of about 3 wt % or more and/or about 50 wt % or less, on a dry weight basis; and/or (c) flaxseed protein in an amount of about 3 wt % or more and/or about 50 wt % or less, on a dry weight basis. Suitably, the creamer composition has a weight ratio of flaxseed oil/flaxseed dietary fibers of about 1.5 or more and/or a weight ratio of flaxseed oil/flaxseed protein of about 1.5 or more.

The creamer composition may comprise dietary fibre, including insoluble and soluble dietary fiber, in any suitable amount. Suitably, the creamer composition comprises: (a) about 13.0 wt % or less insoluble dietary fiber, on a dry weight basis; (b) about 1.0 wt % or more low molecular weight soluble dietary fiber, on a dry weight basis; and/or (c) about 22.0 wt % or less high molecular weight soluble dietary fiber, on a dry weight basis. Suitably, the creamer composition has a weight ratio of soluble dietary fiber/insoluble dietary fiber of about 0.7 or more.

The creamer composition may comprise any other suitable ingredients, such as flavourings, sweeteners, antioxidants, bulking agents, cereals, or a combination thereof. In some embodiments, the creamer composition does not comprise any added emulsifier, buffering agent, and/or hydrocolloid. In some embodiments, the creamer composition further comprises: (a) one or more antioxidant, such as rosemary and/or tocopherol; (b) one or more cereal, such as oat flour; and/or (c) one or more flavouring. In some embodiments, the creamer composition further comprises sugar. In other embodiments, the creamer composition does not comprise added sugar.

In some embodiments, the creamer composition is a liquid creamer. The liquid creamer composition may comprise the ground flaxseed in an amount of about 6 wt % or more, about 7 wt % or more, or about 8 wt % or more; and/or about 10 wt % or less or about 9 wt % or less. In some embodiments, the liquid creamer composition comprises the ground flaxseed in an amount of from about 5 wt % to about 7 wt %. In some embodiments, the liquid creamer composition comprises the ground flaxseed in an amount of about 6 wt %. The liquid creamer composition may have a viscosity of about 100 cP or more, about 140 cP or more, about 160 cP or more, or about 170 cP or more, at 4 °C and a shear rate of 75 s⁻¹. The liquid creamer composition may comprise further ingredients in any suitable amounts. In some embodiments, the liquid creamer composition comprises: (a) one or more antioxidant in a total amount of about 0.05 wt % to about 1 wt % or about 0.1 wt % to about 0.5 wt %; (b) one or more cereal in a total amount of about 0.1 wt % to about 5 wt %; (c) one or more flavouring in a total amount of about 0.1 wt % to about 5 wt %; and/or (d) sugar in a total amount of from about 1 wt % to about 40 wt %.

In some embodiments, the creamer composition is a powder creamer. The powder creamer composition may be provided by any suitable method. In some embodiments, the powder creamer composition is spray-dried. The powder creamer composition may comprise the ground flaxseed in an amount of about 20 wt % or more, about 25 wt % or more, about 30 wt % or more, or about 35 wt % or more, prior to spray-drying.

The creamer composition may be a vegan creamer. In some embodiments, the creamer composition is a beverage creamer, such as a coffee creamer, a tea creamer or a cocoa creamer.

In another aspect, the present invention provides a beverage capsule comprising the creamer composition of the present invention.

In another aspect, the present invention provides a beverage system comprising the creamer composition of the present invention.

In another aspect, the present invention provides a beverage composition comprising the creamer composition of the present invention.

In some embodiments, the beverage composition is a coffee, tea, or cocoa beverage. In some embodiments, the beverage composition is a coffee mix, for example a coffee mix comprising a soluble coffee, the creamer composition of the present invention, optionally sugar and/or a foaming agent.

In another aspect, the present invention provides a method of preparing a beverage composition, comprising: (i) providing a beverage composition base; and (ii) adding the creamer composition of the present invention to the beverage composition base.

In another aspect, the present invention provides a method of producing a flaxseed slurry for use in a creamer composition, the method comprising (a) providing whole or dehulled flaxseed; and (b) wet-milling the flaxseed, preferably using a colloid mill, to provide a flaxseed slurry comprising ground flaxseed.

In another aspect, the present invention provides a flaxseed slurry for use in a creamer composition, wherein the flaxseed slurry comprises ground flaxseed. The ground flaxseed may be wet-milled, preferably using a colloid mill.

In another aspect, the present invention provides a method of producing a liquid creamer composition comprising: (a) providing a flaxseed slurry according to the present invention; (b) optionally mixing the flaxseed slurry with water and/or one or more further creamer ingredient; (c) optionally homogenizing the flaxseed slurry; and (d) sterilizing the flaxseed slurry to provide a liquid creamer composition.

In another aspect, the present invention provides a method of producing a liquid creamer composition comprising: (a) providing a flaxseed slurry according to the present invention; (b) optionally mixing the flaxseed slurry and one or more further creamer ingredient; (c) optionally homogenizing the flaxseed slurry; and (d) drying the flaxseed slurry to provide a powder creamer composition.

In another aspect, the present invention provides use of a flaxseed slurry according to the present invention in a creamer composition, preferably a beverage creamer composition, such as a coffee creamer, a tea creamer or a cocoa creamer.

### DESCRIPTION OF DRAWINGS

FIG. 1—Liquid creamer flaxseed creamers
(A) Creamers 018, 043 and 047 showing good stability. (B) Marbling and phase separation defects of sample 039 comprising 4 wt % ground flaxseed.

FIG. 2—Viscosity profiles of liquid flaxseed creamers

FIG. 3—Homogeneous drink made from flaxseed powder vs flaxseed flour
Suspensions in 150 mL water, 6 g powder/flour, 6 g sugar, and 2 g coffee. (A) Flaxseed powder made via wet milling process. (B) Flaxseed flour made via dry milling process (Glanbia Nutritionals).

FIG. 4—Homogeneous drink made from flaxseed powder vs flaxseed flour over 10 minutes
All suspensions in 150 ml water, 6 g powder/flour, 6 g sugar, and 2 g coffee, and temperature>90 °C. (A) Flaxseed powder (left) and flaxseed flour (right) at Time=0. (B) Flaxseed powder (left) and flaxseed flour (right) at Time=5 minutes. (C) Flaxseed powder (left) and flaxseed flour (right) at Time=10 minutes.

### DETAILED DESCRIPTION

Various preferred features and embodiments of the present invention will now be described by way of non-limiting examples. This disclosure is not limited by the exemplary methods and materials disclosed herein, and any methods and materials similar or equivalent to those described herein can be used in the practice or testing of embodiments of this disclosure. The skilled person will understand that they can combine all features of the invention disclosed herein without departing from the scope of the invention as disclosed.

It must be noted that as used herein and in the appended claims, the singular forms “a”, “an”, and “the” include plural referents unless the context clearly dictates otherwise.

The terms “comprising”, “comprises” and “comprised of” as used herein are synonymous with “including”, “includes”, “containing”, or “contains”, and are inclusive or open-ended and do not exclude additional, non-recited members, elements or steps. The terms “comprising”, “comprises” and “comprised of” also include the term “consisting of”.

Numeric ranges are inclusive of the numbers defining the range. As used herein the term “about” means approximately, in the region of, roughly, or around. When the term “about” is used in conjunction with a numerical value or range, it modifies that value or range by extending the boundaries above and below the numerical value(s) set forth. In general, the terms “about” and “approximately” are used herein to modify a numerical value(s) above and below the stated value(s) by 10%.

The publications discussed herein are provided solely for their disclosure prior to the filing date of the present application. Nothing herein is to be construed as an admission that such publications constitute prior art to the claims appended hereto.

All publications mentioned in the specification are herein incorporated by reference.

### Creamer Compositions

In one aspect, the present invention provides a creamer composition comprising flaxseed.

By a “creamer composition” is meant a composition that is intended to be added to a beverage or food composition, such as e.g. coffee, tea, cocoa or soup, to impart specific characteristics such as colour (e.g. whitening effect), thickening, flavour, texture, and/or other desired characteristics. A creamer composition may be intended to substitute for milk or cream in such beverages or food compositions.

A creamer composition of the invention may be in powdered or liquid form. Suitably, a liquid creamer composition may comprise water in an amount of about 5 wt % to about 95 wt %, or about 10 wt % to about 90 wt %, or about 20 wt % to about 80 wt %. Suitably, a powdered creamer composition may comprise water in an amount of about 5 wt % or less, about 4 wt % or less, or about 3 wt % or less.

In preferred embodiments, the creamer composition is non-dairy. A “non-dairy creamer” is a product intended to substitute for milk or cream when added to coffee, tea, hot chocolate or other beverages. Non-dairy creamers may contain caseinate.

In preferred embodiments, the creamer composition is vegan. A “vegan creamer composition” may be a creamer composition containing no substances derived from animals (including e.g. substances derived from eggs or dairy products).

In preferred embodiments, the creamer composition is plant-based. A “plant-based creamer composition” may be a creamer composition containing no substances other than those derived from plants.

In preferred embodiments, the creamer composition is a beverage creamer. A “beverage creamer” may be a creamer composition which is intended to substitute for milk or cream in coffee, tea, cocoa or other beverages. Suitably, the creamer composition is a coffee creamer, a tea creamer and/or a cocoa creamer. In some embodiments, the creamer composition is a coffee creamer.

### Flaxseed

Flaxseed or linseed is the seed from the flax plant, Linum usitatissimum. Flax seeds occur in two basic varieties, golden (also known as yellow) and brown. The whole flaxseed is flat and oval with pointed tips and contains a seed coat, a thin endosperm, two embryos and an embryo axis. The shell yields good quality fiber and the seed provides oil rich in omega-3, digestible proteins and lignans (see e.g. Bernacchia, R., et al., 2014. Austin J Nutri Food Sci, 2(8), p. 1045).

### Flaxseed Source

The flaxseed used in the present invention may be any suitable variety, including any golden varieties and brown varieties (see e.g. You, F. M., et al., 2016. Canadian Journal of Plant Science, 96(5), pp. 837-852). Basic flaxseed varieties typically have similar nutritional characteristics. Suitably, the flaxseed is a golden variety, such as a NuLin variety or an Omega variety. In some embodiments, the flaxseed is a NuLin variety. In some embodiments, the flaxseed is an Omega variety.

The flaxseed used in the present invention may be whole flaxseed or dehulled flaxseed. In some embodiments, the flaxseed is dehulled. Methods of dehulling flaxseed are well known in the art (see e.g. Oomah, B. D. and Mazza, G., 1997. LWT-Food Science and Technology, 30(2), pp. 135-140). Dehulling of seeds may increase the concentration of oil and protein and decrease the carbohydrate content in dehulled flaxseed.

The flaxseed used in the present invention may be roasted. Roasting the flaxseeds can deactivate undesirable enzymes (e.g. β-glucosidase) and thereby avoid any potential release of residual cyanide.

Conventional roasting conditions will be well known to the skilled person and any suitable roasting conditions may be used. In some embodiments, the flaxseeds are lightly roasted, for example at about 210 °C or less, at about 205 °C or less, at about 200 °C or less, at about 195 °C or less, at about 190 °C or less, at about 185 °C or less, or at about 180 °C or less. Roasting at temperatures of about 210 °C or less can reduce oxidative products responsible for green, fatty, and cheesy flavours. Suitably, the flaxseeds are roasted at about 140 °C to about 180 °C, at about 150 °C to about 170 °C, or about 160 °C. Suitably, the flaxseeds are roasted for about 1 minute to about 10 minutes, for about 2 minutes to about 8 minutes, for about 3 minutes to about 6 minutes, or for about 4 minutes. Suitably, the flaxseeds are roasted at about 140 °C to about 180 °C for about 1 minute to about 10 minutes.

In some embodiments, the flaxseed is roasted whole flaxseed. In some embodiments, the flaxseed is roasted dehulled flaxseed.

The flaxseed used in the present invention may be enzymatically treated. Any suitable enzymatic treatment may be used, for example to reduce the viscosity of the flaxseed slurry following milling. Suitably, the flaxseed is enzymatically treated with one or more polysaccharide-degrading enzymes. Suitable polysaccharide-degrading enzymes may include glycosidases (EC 3.2.1), such as cellulase (EC 3.2.1.4) and xylanase (EC 3.2.1.8). In some embodiments, the flaxseed is enzymatically treated with one or more glycosidase. In some embodiments, the flaxseed is enzymatically treated with cellulase and/or xylanase. In some embodiments, the flaxseed is enzymatically treated with cellulase and xylanase.

In some embodiments, the flaxseed is roasted whole flaxseed. In some embodiments, the flaxseed is roasted dehulled flaxseed. In some embodiments, the flaxseed is roasted enzymatically treated whole flaxseed. In some embodiments, the flaxseed is roasted enzymatically treated dehulled flaxseed.

### Ground Flaxseed

In preferred embodiments, the flaxseed is wet-milled. In other preferred embodiments, the flaxseed is colloid-milled. In more preferred embodiments, the flaxseed is wet-milled using a colloid mill. Without wishing to be bound by theory, the inventors understand that in flaxseed oil bodies, the triglyceride of the oil droplets is surrounded by a single layer of phospholipids intertwined with the protein oleosin. The inventors found that this structure was largely undamaged during wet-milling and so the liberation of free oil is avoided in the creamer. The soluble fibre that coats the flaxseed is extracted and activated during wet-milling to become a viscous mucilage that contributes to the creamer's desirable texture and provides the viscosity required to suspend the creamer dispersion giving the creamer stability. The present inventors have surprisingly found that by processing flaxseeds through wet milling (for example using a colloid mill), the mucilage layer stabilizes the oil bodies and so protects against rupture or, if damage occurs, reduces coalescence of any oil released.

Wet milling, also known as wet grinding, is a process through which particles that are suspended in a liquid slurry are dispersed in that liquid by shearing or crushing. Colloid Mills are designed for the production of colloidal solutions, or extremely fine emulsions and suspensions. High tip speeds, combined with an extremely small shear gap, produces intense friction on the material being processed (see e.g. King, A. G. and Keswani, S. T., 1994. Journal of the American Ceramic Society, 77(3), pp. 769-777).

The flaxseed may have any suitable particle size, which may be determined by any suitable method known in the art. Suitably, the particle size is determined by laser light scattering, for example static light scattering (SLS). Suitably, the particle size is expressed as the D90 or D(3,2). The D90 or Dv(90) is the diameter where ninety percent of the distribution by volume has a smaller particle size. For a material such as flaxseed, the distribution by volume and the distribution by mass can be considered to be equivalent. The D(3,2) is the surface area moment mean.

Suitably, the flaxseed has a particle size D90 of about 900 μm or less, about 850 μm or less, about 800 μm or less, about 750 μm or less, about 700 μm or less, about 650 μm or less, about 600 μm or less, about 550 μm or less, or about 500 μm or less. Suitably, the flaxseed has a particle size D90 of about 50 μm or more.

Suitably, the flaxseed has a particle size D(3,2) of about 25 μm or less, about 20 μm or less, about 15 μm or less, about 10 μm or less, about 9 μm or less, about 8 μm or less, about 7 μm or less, about 6 μm or less, or about 5 μm or less. Suitably, the flaxseed has a particle size D(3,2) of about 1 μm or more.

### Flaxseed Content

The creamer composition of the present invention may comprise the flaxseed in any suitable amount. Suitably, the creamer composition comprises the flaxseed in an amount of about 3.0 wt % or more, about 3.5 wt % or more, about 4.0 wt % or more, about 4.5 wt % or more, about 5.0 wt % or more, about 5.5 wt % or more, 6.0 wt % or more, about 6.5 wt % or more, about 7.0 wt % or more, about 7.5 wt % or more, or about 8.0 wt % or more.

Preferably, the creamer composition comprises the flaxseed in an amount of about 5.0 wt % or more, about 5.5 wt % or more, 6.0 wt % or more, about 6.5 wt % or more, about 7.0 wt % or more, about 7.5 wt % or more, or about 8.0 wt % or more.

In some embodiments, the creamer composition comprises the flaxseed in an amount of about 5.0 wt % or more. In some embodiments, the creamer composition comprises the flaxseed in an amount of about 5 wt %.

In some embodiments, the creamer composition comprises the flaxseed in an amount of about 6.0 wt % or more. In some embodiments, the creamer composition comprises the flaxseed in an amount of about 6 wt %

Suitably, the creamer composition comprises the flaxseed in an amount of about 5 wt % or more, 6 wt % or more, 7 wt % or more, 8 wt % or more, 9 wt % or more, about 10 wt % or more, 11 wt % or more, 12 wt % or more, 13 wt % or more, 14 wt % or more, 15 wt % or more, 16 wt % or more, 17 wt % or more, 18 wt % or more, 19 wt % or more, or 20 wt % or more, on a dry weight basis.

### Flaxseed Oil, Protein, and Dietary Fibre Content

The creamer composition of the present invention may comprise flaxseed oil, flaxseed protein, and flaxseed dietary fibre. The creamer composition of the present invention is preferably not sieved or strained and retains substantially all the flaxseed oil, flaxseed protein, and flaxseed dietary fibre present in the flaxseed source.

The oil, protein, and dietary fibre may be present in any suitable amounts, typically depending on the flaxseed source (e.g. variety, whole or dehulled, etc.). Typically, whole flaxseed comprises oil in an amount of about 40 wt % to about 50 wt %, protein in an amount of about 15 wt % to about 25 wt %, and dietary fibre in an amount of about 15 wt % to about 30 wt %.

Suitably, the creamer composition comprises flaxseed oil in an amount of about 5 wt % or more, about 10 wt % or more, about 15 wt % or more, about 20 wt % or more, about 25 wt % or more, about 30 wt % or more, or about 35 wt % or more, on a dry weight basis. Suitably, the creamer composition comprises flaxseed oil in an amount of about 70 wt % or less, about 65 wt % or less, about 60 wt % or less, about 55 wt % or less, or about 50 wt % or less, on a dry weight basis. Suitably, the creamer composition comprises flaxseed oil in an amount of about 5 wt % to about 70 wt %, about 5 wt % to about 65 wt %, about 5 wt % to about 60 wt %, about 5 wt % to about 55 wt %, or about 5 wt % to about 50 wt %, on a dry weight basis.

Suitably, the creamer composition comprises flaxseed dietary fiber in an amount of about 1 wt % or more, about 2 wt % or more, about 3 wt % or more, about 4 wt % or more, about 5 wt % or more, about 10 wt % or more, or about 15 wt % or more, on a dry weight basis. Suitably, the creamer composition comprises flaxseed dietary fiber in an amount of about 50 wt % or less, about 45 wt % or less, about 40 wt % or less, about 35 wt % or less, about 30 wt % or less, about 25 wt % or less, or about 20 wt % or less, on a dry weight basis. Suitably, the creamer composition comprises flaxseed dietary fiber in an amount of about 1 wt % to about 50 wt %, about 1 wt % to about 45 wt %, about 1 wt % to about 40 wt %, about 1 wt % to about 35 wt %, about 1 wt % to about 30 wt %, about 1 wt % to about 25 wt %, or about 1 wt % to about 20 wt %, on a dry weight basis.

Suitably, the creamer composition comprises flaxseed protein in an amount of about 1 wt % or more, about 2 wt % or more, about 3 wt % or more, about 4 wt % or more, about 5 wt % or more, about 10 wt % or more, or about 15 wt % or more, on a dry weight basis. Suitably, the creamer composition comprises flaxseed protein in an amount of about 50 wt % or less, about 45 wt % or less, about 40 wt % or less, about 35 wt % or less, about 30 wt % or less, about 25 wt % or less, or about 20 wt % or less, on a dry weight basis. Suitably, the creamer composition comprises flaxseed protein in an amount of about 1 wt % to about 50 wt %, about 1 wt % to about 45 wt %, about 1 wt % to about 40 wt %, about 1 wt % to about 35 wt %, about 1 wt % to about 30 wt %, about 1 wt % to about 25 wt %, about 1 wt % to about 20 wt %, on a dry weight basis.

Suitably, the creamer composition comprises: (a) flaxseed oil in an amount of about 5 wt % to about 70 wt % (for example about 10 wt % to about 50 wt %); (b) flaxseed dietary fiber in an amount of about 1 wt % to about 50 wt % (for example about 3 wt % to about 40 wt %); and/or (c) flaxseed protein in an amount of about 1 wt % to about 50 wt % (for example about 3 wt % to about 40 wt %), all on a dry weight basis. Suitably, the creamer composition comprises: (a) flaxseed oil in an amount of about 5 wt % to about 70 wt % (for example about 10 wt % to about 50 wt %); (b) flaxseed dietary fiber in an amount of about 1 wt % to about 50 wt % (for example about 3 wt % to about 40 wt %) and (c) flaxseed protein in an amount of about 1 wt % to about 50 wt % (for example about 3 wt % to about 40 wt %), all on a dry weight basis.

Suitably, the creamer composition has a weight ratio of flaxseed oil/flaxseed dietary fiber of about 1.5 or more, about 2.0 or more, about 2.5 or more, or about 3.0 or more. Suitably, the creamer composition has a weight ratio of flaxseed oil/flaxseed protein of about 1.5 or more, about 2.0 or more, about 2.5 or more, or about 3.0 or more.

Suitably, the creamer composition comprises about 13.0 wt % or less, about 12.0 wt % or less, about 11.0 wt % or less, about 10.0 wt % or less, about 9.0 wt % or less, or about 8.0 wt % or less insoluble dietary fiber, on a dry weight basis.

Suitably, the creamer composition comprises about 2.0 wt % or more, about 3.0 wt % or more, about 4.0 wt % or more, about 5.0 wt % or more, 6.0 wt % or more, or 7.0 wt % or more soluble dietary fiber, on a dry weight basis.

Suitably, the creamer composition has a weight ratio of soluble dietary fiber/insoluble dietary fiber of about 0.7 or more, about 0.8 or more, about 0.9 or more, or about 1.0 or more.

Suitably, the creamer composition comprises about 1.0 wt % or more, about 1.5 wt % or more, about 2.0 wt % or more, 2.5 wt % or more, 3.0 wt % or more, or 3.5 wt % or more low molecular weight soluble dietary fiber, on a dry weight basis. Low molecular weight soluble dietary fiber may have a degree of polymerisation (DP) of 9 or less.

Suitably, the creamer composition comprises about 22.0 wt % or less, about 20.0 wt % or less, about 18.0 wt % or less, about 16.0 wt % or less, about 14.0 wt % or less, or about 12.0 wt % or less high molecular weight soluble dietary fiber, on a dry weight basis. High molecular weight soluble dietary fiber may have a degree of polymerisation (DP) of 10 or more.

### Other Creamer Ingredients

The creamer composition may comprise any other suitable ingredients. The creamer composition may further include one or more ingredients such as flavourings, sweeteners, colorants, antioxidants, stabilising agents, pH control agents, buffering agents, bulking agents, foaming agents, cereals, or a combination thereof.

In some embodiments, the creamer composition comprises flaxseed and is substantially devoid of any other ingredients. By “substantially devoid” is meant that no additional agents are added as such to the composition, and that any additional agents present originate from minor traces or impurities present in the other components.

In some embodiments, the creamer composition comprises or consists of flaxseed and one other ingredient. In some embodiments, the creamer composition comprises or consists of flaxseed and two other ingredients. In some embodiments, the creamer composition comprises or consists of flaxseed and three other ingredients.

In some embodiments, the creamer composition does not comprise any added emulsifier, hydrocolloid, pH control agent, or buffering agent. The term “added” is not meant to include agents present in minor amounts as natural constituents of other ingredients of the creamer composition.

### Flavourings, Sweeteners, Colorants, and Antioxidants

In some embodiments, the creamer composition comprises one or more flavourings, sweeteners, colorants, antioxidants, or a combination thereof. In some embodiments, the creamer composition comprises one or more flavourings, one or more sweeteners, and one or more antioxidants (e.g. rosemary and/or tocopherol). The oil bodies provide a natural protection against oxidation, for example oil bodies comprised within flaxseed which has been subjected to wet-milling, but in case some rupture of the oil bodies occurs, the presence of an antioxidant protects any released oil from oxidation which can lead to rancid tastes.

Suitably, the creamer composition may comprise the one or more flavourings, sweeteners, colorants, antioxidants, or a combination thereof in a total amount of at least about 0.1 wt %, at least about 0.5 wt %, or at least about 1 wt %. Suitably, the creamer composition may comprise the one or more flavourings, sweeteners, colorants, antioxidants, or a combination thereof in a total amount of from about 0.1 wt % to 10 wt %, from about 0.5 wt % to about 10 wt %, or from about 1 wt % to about 10 wt %.

In other embodiments, the creamer composition is substantially devoid of any flavourings, sweeteners, colorants, and/or antioxidants.

The list of known flavouring agents includes thousands of molecular compounds which are well known in the art. Sweeteners can include, but are not limited to, sugar alcohols such as maltitol, xylitol, sorbitol, erythritol, mannitol, isomalt, lactitol, hydrogenated starch hydrolysates, and the like, alone or in combination. Colorants include any substance that imparts colour to the composition. Antioxidants include any substance that reduces oxidation, such as rosemary and tocopherol. Usage level of the flavourings, sweeteners, colorants, and antioxidants will vary greatly and will depend on such factors as potency of the sweetener, desired sweetness of the product, level and type of flavouring used and cost considerations.

### Stabilising Agents

In some embodiments, the creamer composition is substantially devoid of any stabilising agents. In some embodiments, the creamer composition does not comprise any added emulsifier and/or hydrocolloid.

Stabilising agents can include emulsifiers, thickeners and gelling agents, foam stabilizers, humectants, anticaking agents, and coating agents. For example, stabilising agents can include hydrocolloids which are compounds that help to increase physical viscosity of the composition. Suitable hydrocolloids may be carrageenan, such as kappa-carragenan, iota-carragenan, and/or lambda-carragenan; starch, e.g. modified starch; cellulose, e.g. microcrystalline cellulose, methyl cellulose, or carboxy-methyl cellulose; agar-agar; gelatine; gellan (e.g., high acyl, low acyl); guar gum; gum Arabic; kojac; locust bean gum; pectin; sodium alginate; maltodextrin; tracaganth; xanthan; or a combination thereof.

### pH Control Agents and Buffering Agents

In some embodiments, the creamer composition is substantially devoid of any pH control agents or buffering agents. In some embodiments, the creamer composition does not comprise any added buffer salts.

As used herein, a “pH control agent” is an additive used to change or maintain the pH of a composition and includes bases, acids, neutralising agents, and buffering agents. Any suitable pH control agent may be used, for example a base. Suitable bases may include a carbonate salt or a solution thereof, a bicarbonate salt (hydrogen carbonate salt) or a solution thereof, or a hydroxide salt or a solution thereof, or a combination thereof. Bases may be selected from one or more of: calcium carbonate, ammonium carbonate, magnesium carbonate, potassium carbonate, sodium carbonate, ammonium hydrogen carbonate, magnesium hydroxide carbonate, potassium hydrogen carbonate, sodium hydrogen carbonate, sodium sesquicarbonate, ammonium hydroxide, calcium hydroxide, magnesium hydroxide, potassium hydroxide, and sodium hydroxide; or a solution thereof.

As used herein, a “buffering agent” can prevent undesired creaming, flocculation or precipitation of the creamer upon addition into a hot, acidic and/or high mineral environment such as coffee by maintaining a constant pH. The buffering agent can be, for example, citrate, monophosphates, diphosphates, sodium mono- and bicarbonates, potassium mono- and bicarbonates, or a combination thereof. In some embodiments, the buffering agent is citrate, e.g. created in situ by addition of sodium bicarbonate and citric acid. In some embodiments, buffers are salts such as potassium phosphate or dipotassium phosphate.

### Bulking Agents

In some embodiments, the creamer composition comprises one or more bulking agent.

Bulking agents are additives that increase the bulk (volume or weight) of a composition without significantly affecting its taste and whilst keeping its utility and functionality intact. Suitably, bulking agents may comprise or consist of one or more of: syrups; soluble/insoluble fibers, preferably derived from corn, wheat, pea, rice, oat, coconut, barley and/or tapioca; fructo- and galacto-oligosaccharides; and hydrolysed cereal flour. In some embodiments, the bulking agent comprises or consists of one or more of: glucose syrup, powdered glucose, starch, corn syrup solids, maltodextrin, and dextrin. In some embodiments, the bulking agent is sugar.

In some embodiments, the creamer composition comprises flaxseed and a bulking agent and is substantially devoid of any other added ingredients. In some embodiments, the creamer composition comprises added sugar.

Suitably, the creamer composition may comprise the one or more bulking agents in a total amount of at least about 1 wt %, at least about 5 wt %, or at least about 10 wt %. Suitably, the creamer composition may comprise the one or more bulking agents in a total amount of from about 1 wt % to 50 wt %, from about 5 wt % to about 50 wt %, or from about 10 wt % to about 50 wt %.

In other embodiments, the creamer composition is substantially devoid of any added bulking agent. In some embodiments, the creamer composition does not comprise added sugar.

### Foaming Agents

The creamer composition of the invention may be a foaming creamer, i.e. a creamer that produces foam when dissolved in a liquid. Foaming creamers and methods for producing them are well known in the art. A foaming creamer may e.g. be a powdered creamer composition wherein the creamer powder particles are porous and gas is released from the pores upon dissolution to produce foam.

In some embodiments, the creamer composition comprises one or more foaming agent.

The creamer composition may comprise the one or more foaming agent in any suitable amount. Suitably, the creamer composition may comprise the one or more foaming agent in an amount of at least about 0.1 wt %, or at least about 1 wt %. Suitably, the creamer composition may comprise the one or more foaming agent in an amount of from about 0.1 wt % to 10 wt %, or from about 1 wt % to about 10 wt %.

As used herein, a “foaming agent” (also called a “foaming aid”) is an additive that facilitates the formation of foam. For example, foaming agents can include surfactants that reduce surface tension of a liquid or increase colloidal stability by inhibiting coalescence of bubbles. Any suitable foaming agent may be used in any suitable amount.

In some embodiments, the foaming agent comprises or consists of one or more of: plant protein, optionally wherein the plant protein is selected from one or more of faba bean protein, pea protein, rice protein, oat protein, soy protein; milk protein (for example hydrolysed milk protein); polysaccharide; and saponin, optionally wherein the saponin is derived from quillaja.

In some embodiments, the foaming agent comprises or consists of plant protein, optionally wherein the plant protein is selected from one or more of faba bean protein, pea protein, rice protein, oat protein, soy protein. The plant protein may be a plant protein isolate and/or hydrolysed plant protein. In some embodiments, the foaming agent comprises plant protein isolate and/or hydrolysed plant protein.

In some embodiments, the creamer composition comprises flaxseed, a bulking agent, and a foaming agent (e.g. plant protein) and is substantially devoid of any other added ingredients.

### Cereals, Legumes, Nuts, Seeds, Pseudo-Cereals

In some embodiments, the creamer composition comprises one or more plant material, in addition to flaxseed.

Any suitable plant material may be used. For example, plant material that has previously been used in plant-based milk alternatives, such as cereals (e.g. oat, rice, corn, spelt, barley), legumes (e.g. soy, peanut, lupin, cowpea), nuts (e.g. almond, coconut, hazelnut, pistachio, walnut), seeds (e.g. sesame, hemp, sunflower), or pseudo-cereals (e.g. quinoa, teff, amaranth) (see e.g. Sethi, S., et al., 2016. Journal of food science and technology, 53, pp. 3408-3423). In some embodiments, the creamer composition comprises one or more cereal. In some embodiments, the creamer composition comprises oat. The plant material may be provided in the form of a powder or flour. In some embodiments, the creamer composition comprises oat flour.

The creamer composition may comprise the additional plant material in any suitable amount. Suitably, the creamer composition may comprise the additional plant material in an amount of at least about 0.1 wt %, or at least about 1 wt %. Suitably, the creamer composition may comprise the additional plant material in an amount of from about 0.1 wt % to 10 wt %, or from about 1 wt % to about 5 wt %.

### Liquid Creamer Compositions

In one embodiment, the present invention provides a liquid creamer composition comprising flaxseed.

A liquid creamer composition of the present invention may comprises the flaxseed in any suitable amount. Suitably, the liquid creamer composition comprises the flaxseed in an amount of about 4.5 wt % or more, about 5.0 wt % or more, about 5.5 wt % or more, 6.0 wt % or more, about 6.5 wt % or more, 7.0 wt % or more, about 7.5 wt % or more, or about 8.0 wt % or more. Suitably, the liquid creamer composition comprises the flaxseed in an amount of about 10.0 wt % or less, about 9.5 wt % or less, about 9.0 wt % or less, or about 8.5 wt % or less.

Suitably, the liquid creamer composition comprises the flaxseed in an amount of about 5 wt % to about 10 wt %, from about 5 wt % to about 9 wt %, from about 5 wt % to about 8 wt %, or from about 5 wt % to about 7 wt %. Preferably, the liquid creamer composition comprises the flaxseed in an amount of from about 5.0 wt % to about 7.0 wt %, from about 5.5 wt % to about 6.5 wt %, or about 6.0 wt %.

A liquid creamer composition of the present invention may have a viscosity of about 100 cP or more, about 105 cP or more, about 110 cP or more, about 115 cP or more, about 120 cP or more, about 125 cP or more, about 130 cP or more, about 135 cP or more, about 140 cP or more, about 145 cP or more, about 150 cP or more, about 155 cP or more, about 160 cP or more, about 165 cP or more, about 170 cP or more, about 175 cP or more, or about 180 cP or more, wherein the viscosity is determined at 4 °C and at a shear rate of 75 s⁻¹.

The liquid creamer composition may comprise any other suitable ingredients. In some embodiments, the liquid creamer composition comprises one or more flavourings, one or more sweeteners, and one or more antioxidants (e.g. rosemary and/or tocopherol). In some embodiments, the liquid creamer composition further comprises sugar. In other embodiments, the liquid creamer composition does not comprises added sugar.

In some embodiments, the liquid creamer composition comprises one or more antioxidants in a total amount of about 0.05 wt % or more, about 0.1 wt % or more, or about 0.5 wt % or more. In some embodiments, the liquid creamer composition comprises one or more antioxidants in a total amount of about 2.0 wt % or less, 1.0 wt % or less, or 0.5 wt % or less. In some embodiments, the liquid creamer composition comprises one or more antioxidants in a total amount of from about 0.05 wt % to about 1.0 wt %, from about 0.1 wt % to about 1.0 wt %, or from about 0.5 wt % to about 1.0 wt %.

In some embodiments, the liquid creamer composition comprises one or more cereals in a total amount of about 0.1 wt % or more, about 0.5 wt % or more, or about 1.0 wt % or more. In some embodiments, the liquid creamer composition comprises one or more cereals in a total amount of about 5.0 wt % or less. In some embodiments, the liquid creamer composition comprises one or more cereals in a total amount of from about 0.1 wt % to about 5.0 wt %, from about 0.5 wt % to about 5.0 wt %, or from about 1.0 wt % to about 5.0 wt %.

In some embodiments, the liquid creamer composition comprises one or more flavourings in a total amount of about 0.1 wt % or more, about 0.5 wt % or more, or about 1.0 wt % or more. In some embodiments, the liquid creamer composition comprises one or more flavourings in a total amount of about 5.0 wt % or less. In some embodiments, the liquid creamer composition comprises one or more flavourings in a total amount of from about 0.1 wt % to about 5.0 wt %, from about 0.5 wt % to about 5.0 wt %, or from about 1.0 wt % to about 5.0 wt %.

In some embodiments, the liquid creamer composition comprises: (a) one or more antioxidant in a total amount of about 0.05 wt % to about 1 wt % or about 0.1 wt % to about 0.5 wt %; (b) one or more cereal in a total amount of about 0.1 wt % to about 5 wt %; and (c) one or more flavouring in a total amount of about 0.1 wt % to about 5 wt %.

In some embodiments, the liquid creamer composition comprises sugar in a total amount of about 1 wt % or more, about 5 wt % or more, or about 10 wt % or more. In some embodiments, the liquid creamer composition comprises sugar in a total amount of about 40 wt % or less, about 30 wt % or less, or about 20 wt % or less. In some embodiments, the liquid creamer composition comprises sugar in a total amount of from about 1 wt % to about 40 wt %, from about 5 wt % to about 40 wt %, or from about 10 wt % to about 40 wt %.

In some embodiments, the liquid creamer composition comprises: (a) one or more antioxidant in a total amount of about 0.05 wt % to about 1 wt % or about 0.1 wt % to about 0.5 wt %; (b) one or more cereal in a total amount of about 0.1 wt % to about 5 wt %; (c) one or more flavouring in a total amount of about 0.1 wt % to about 5 wt %; and (d) sugar in a total amount of from about 1 wt % to about 40 wt %.

The liquid creamer composition may be packaged. Any suitable packaging may be used, for example, the liquid creamer composition may be aseptically-filled in a bottle.

### Powder Creamer Compositions

In one embodiment, the present invention provides a powder creamer composition comprising flaxseed.

A powder (or powdered) creamer composition may be provided by any suitable method, for example by drying a liquid creamer composition, such as by spray-drying or freeze-drying. In some embodiments, the creamer composition is spray-dried.

A powder creamer composition of the present invention may comprises the flaxseed in any suitable amount. Suitably, the powder creamer composition comprises the flaxseed in an amount of about 10 wt % or more, 15 wt % or more, 20 wt % or more, 25 wt % or more, 30 wt % or more, 35 wt % or more, 40 wt % or more, 45 wt % or more, 50 wt % or more, 60 wt % or more, or 70 wt % or more, on a dry weight basis. Suitably, the powder creamer composition comprises the flaxseed in an amount of about 20 wt % or more, about 25 wt % or more, about 30 wt % or more, or about 35 wt % or more, prior to spray-drying.

In some embodiments, the powder creamer composition is substantially devoid of any other ingredients. In other embodiments, the powder creamer composition comprises one or more further ingredients, such as coffee, sugar, chicory, barley, baking soda, tea extract etc. In some embodiments, the powder creamer composition further comprises a soluble coffee and/or sugar. In some embodiments, the powder creamer composition further comprises a foaming agent. The powder creamer composition may comprise a porous powder containing gas under pressure which is released upon dissolution of the powder generating a foam, such powders are often referred to as “foam boosters”.

The powder creamer composition may be packaged. Any suitable packaging may be used.

### Beverages, Capsules, and Systems

### Beverage Composition

The present invention provides a beverage composition comprising the creamer composition described herein. The beverage may be any suitable beverage such as a coffee, tea, or cocoa beverage. The beverage composition may be a ready-to-drink beverage or a ready-to-use beverage.

The present invention further provides a powdered coffee, tea, or cocoa beverage composition comprising soluble coffee, tea, or cocoa and a powdered creamer composition according to the invention. By a powdered coffee, tea, or cocoa beverage composition is meant a powdered composition suitable for providing a coffee, tea, or cocoa beverage by dissolution in a liquid, preferably water, such as instant coffee, instant tea, or instant cocoa. Powdered coffee, tea, or cocoa beverage compositions comprising soluble coffee, tea, or cocoa in combination with powdered creamer are well known in the art. A packaged combination of soluble coffee, creamer powder and optionally sugar may be known as a coffee mix. Powdered coffee, tea, or cocoa beverages may further comprise sweeteners, e.g. sugar, and flavours. In a preferred embodiment, the invention relates to a powdered coffee beverage comprising soluble coffee and a powdered creamer composition according to the invention. In another preferred embodiment, the invention relates to a powdered tea beverage comprising soluble tea and a powdered creamer composition according to the invention.

The present invention further provides a method of preparing a beverage composition, comprising: (i) providing a beverage composition base; and (ii) adding the creamer composition described herein to the beverage composition base.

The beverage composition base may be any suitable beverage such as a coffee, tea, or cocoa beverage. The creamer composition may be added in powder or liquid form to the beverage composition base. The creamer composition may impart specific characteristics such as colour (e.g. whitening effect), thickening, flavour, texture, and/or other desired characteristics, for example as a substitute for milk or cream as an additive to the beverage composition.

### Beverage Capsule

The present invention provides a beverage capsule comprising the creamer composition described herein. The beverage capsule may comprise the powdered creamer composition of the invention.

Beverage capsules are well known in the art and any suitable capsule may be used. In the scope of the present invention, the term capsule includes small flexible and/or rigid containers for example pouches. The construction of the capsule will depend on the particular beverage machine(s) for which is intended to be used. Several such beverage machines adapted to the preparation of beverages from capsules exists and are well known in the art. The beverage capsule comprises a chamber wherein the powdered creamer composition of the invention is present. The chamber may be hermetically sealed or it may be partly open to the environment. Beverage capsules are constructed such that water, or another suitable liquid, can be injected into the chamber where the powdered creamer composition of the invention is present so that the powdered creamer composition is dissolved when a beverage is prepared from the capsule in a beverage preparation apparatus. The liquid with dissolved creamer is led from the capsule into a cup or other suitable container.

### Beverage System

The present invention provides a beverage system comprising the creamer composition described herein. The beverage system may comprise the powdered creamer composition of the invention.

Beverage systems are well known in the art and widely available commercially. Any suitable beverage system may be used. Beverage systems include beverage preparation machines, automated systems for dispensing beverages (e.g. beverage vending machines), and the like. Beverage preparation systems for portioned beverage are well known in the art. They usually comprise a machine into which one or more ingredient containers (e.g. beverage capsule) are inserted. The machine is able to pass a fluid, typically hot water through an ingredient contained in the container, so as to produce a beverage.

### Flaxseed Slurries for Use in a Creamer Composition

In one aspect, the present invention provides a flaxseed slurry for use in a creamer composition.

The flaxseed slurry may comprise or consist of ground flaxseed and water. The flaxseed slurry may be obtained or obtainable by a method of producing a flaxseed slurry, according to the present invention.

Any suitable flaxseed source may be used in the flaxseed slurry, as described in the section above entitled “Flaxseed source”. For example, the flaxseed may be whole or dehulled, roasted, and/or enzymatically treated.

The flaxseed slurry may be obtained by wet-milled using a colloid mill. The flaxseed slurry may comprise ground flaxseed having any suitable particle size, as described in the section above entitled “Ground flaxseed”.

Suitably, the flaxseed slurry comprises ground flaxseed having a particle size D90 of about 900 μm or less, about 850 μm or less, about 800 μm or less, about 750 μm or less, about 700 μm or less, about 650 μm or less, about 600 μm or less, about 550 μm or less, or about 500 μm or less. Suitably, the flaxseed slurry comprises ground flaxseed having a particle size D90 of about 50 μm or more.

Suitably, the flaxseed slurry comprises ground flaxseed having a particle size D(3,2) of about 25 μm or less, about 20 μm or less, about 15 μm or less, about 10 μm or less, about 9 μm or less, about 8 μm or less, about 7 μm or less, about 6 μm or less, or about 5 μm or less. Suitably, the flaxseed slurry comprises ground flaxseed having a particle size D(3,2) of about 1 μm or more.

The flaxseed slurry may comprise ground flaxseed in any suitable amount. Suitably, the flaxseed slurry comprises ground flaxseed in an amount of about 5 wt % or more, about 6 wt % or more, about 7 wt % or more, about 8 wt % or more, about 9% or more, or about 10% or more. Suitably, the flaxseed slurry comprises ground flaxseed in an amount of about 35% or less, about 15 wt % or less, about 14 wt % or less, about 13 wt % or less, about 12 wt % or less, about 11 wt % or less, about 10 wt % or less, or about 9 wt % or less. The flaxseed slurry may be a paste.

The flaxseed slurry may comprise flaxseed oil, flaxseed protein, and flaxseed dietary fibre in any suitable amount, as described in the section above entitled “Flaxseed oil, protein, and dietary fibre content”. The flaxseed slurry may comprise or substantially consist of flaxseed oil, flaxseed protein, flaxseed dietary fibre, and water.

### Methods of Producing a Flaxseed Slurry

In one aspect, the present invention provides a method of producing a flaxseed slurry for use in a creamer composition. The method may comprise: (a) providing flaxseed; and (b) wet-milling the flaxseed to provide a flaxseed slurry comprising ground flaxseed.

Any suitable flaxseed source may be used in the flaxseed slurry, as described in the section above entitled “Flaxseed source”. For example, the flaxseed may be whole or dehulled, and/or roasted.

The flaxseed may be wet-milled using a colloid mill. The flaxseed may be milled to any suitable particle size, as described in the section above entitled “Ground flaxseed”.

Suitably, the flaxseed is milled to a particle size D90 of about 900 μm or less, about 850 μm or less, about 800 μm or less, about 750 μm or less, about 700 μm or less, about 650 μm or less, about 600 μm or less, about 550 μm or less, or about 500 μm or less. Suitably, the flaxseed is milled to a particle size D90 of about 50 μm or more.

Suitably, the flaxseed is milled to a particle size D(3,2) of about 25 μm or less, about 20 μm or less, about 15 μm or less, about 10 μm or less, about 9 μm or less, about 8 μm or less, about 7 μm or less, about 6 μm or less, or about 5 μm or less. Suitably, the flaxseed is milled to a particle size D(3,2) of about 1 μm or more.

In some embodiments, the flaxseed is enzymatically treated prior to, during and/or after wet-milling. In some embodiments, the flaxseed is enzymatically treated prior to wet-milling. some embodiments, the flaxseed slurry is enzymatically treated after wet-milling. Any suitable enzymatic treatment may be used, for example to reduce the viscosity of the flaxseed slurry following milling. Suitably, the flaxseed is enzymatically treated with one or more polysaccharide-degrading enzymes. Suitable polysaccharide-degrading enzymes may include glycosidases (EC 3.2.1), such as cellulase (EC 3.2.1.4) and xylanase (EC 3.2.1.8). In some embodiments, the flaxseed is enzymatically treated with one or more glycosidase. In some embodiments, the flaxseed is enzymatically treated with cellulase and/or xylanase. In some embodiments, the flaxseed is enzymatically treated with cellulase and xylanase.

In some embodiments, the flaxseed slurry is homogenised after the wet-milling. Any suitable homogenisation conditions may be used in order to achieve an even distribution of ground flaxseed. Suitably, the flaxseed slurry is homogenised at about 60 °C to about 90 °C. Suitably, the flaxseed slurry is homogenised in a two-stage homogeniser. The flaxseed slurry may be homogenised in a two-stage homogeniser at conditions with a first stage pressure between 150 bar and 250 bar and a second stage pressure being between 15% and 35% of the first stage pressure.

Suitably, water is added to the flaxseed slurry after wet-milling and/or homogenisation (for example when preparing a liquid creamer) to provide a flaxseed slurry having a desired amount of ground flaxseed and/or a desired viscosity. Suitably, water is added to provide a flaxseed slurry comprising ground flaxseed in an amount of about 5 wt % or more, about 6 wt % or more, about 7 wt % or more, about 8 wt % or more, about 9% or more, or about 10% or more. Suitably, water is added to provide a flaxseed slurry comprising ground flaxseed in an amount of about 15 wt % or less, about 14 wt % or less, about 13 wt % or less, about 12 wt % or less, about 11 wt % or less, about 10 wt % or less, or about 9 wt % or less.

Any other suitable steps may be incorporated into the method of producing a flaxseed slurry. For example, the method may comprise a step of soaking the flaxseed in water prior to, during and/or after wet-milling. In some embodiments, the whole is soaked in water prior to wet-milling. Suitably, the water is at a temperature of from about 25 °C to about 90 °C, from about 25 °C to about 75 °C, from about 25 °C to about 60 °C, or from about 25 °C to about 45 °C. Suitably, the flaxseed is soaked in water for from about 10 minutes to about 30 minutes, or from about 10 minutes to about 20 minutes. Suitably, the whole flaxseed is soaked in water at a weight ratio of whole flaxseed:water of from about 1:20 to about 3:10, from about 1:10 to about 3:10, from about 1:10 to about 1:5, or from about 1:5 to about 3:10. In other embodiments, the method does not comprise a step of soaking the flaxseed in water.

The flaxseed slurry obtained by the method of producing a flaxseed slurry may be any flaxseed slurry described herein, for example described above in the section entitled “Flaxseed slurries for use in a creamer composition”.

### Methods of Producing a Creamer Composition

In one aspect, the present invention provides a method of producing a creamer composition, the method comprising providing a flaxseed slurry according to the present invention and (i) sterilizing the flaxseed slurry to provide a liquid creamer composition; or (ii) drying the flaxseed slurry to provide a powder creamer composition.

Any other suitable steps may be incorporated into the method of producing a creamer composition, such as those described below.

For example, the method may comprise a step of homogenizing the flaxseed slurry. The term “homogenising” or “homogenised” or homogenisation” is a unit operation using a class of processing equipment referred to as homogenisers that are geared towards reducing the size of droplets in liquid-liquid dispersions. Examples of homogenisers may include high speed blender, high pressure homogenisers, high shear dispersers, ultrasonic disruptor, and membrane homogenisers. The homogeniser may be a two-step homogeniser.

For example, the method may comprise a heat treatment step. The heat treatment step may be performed before or after homogenisation. The heat treatment step may be a step of pasteurizing or commercially sterilizing the flaxseed slurry. Suitable heat treatment steps are well known in the art. A pasteurizing step may be performed at a minimum temperature of 81 °C for at least 5 seconds. The method may comprise steps of HTST (high temperature short time) or UHT (Ultra-high temperature processing) using either direct or indirect process; and filled on a clean fill, ultra clean fill (ESL) or aseptic filler. UHT treatment may be for example heating to above 135 °C (the temperature required to kill bacterial endospores) for 2 to 8 seconds. For example the UHT treatment may be heating to between 138 °C and 140 °C for 5 to 7 seconds.

For example, the method may comprises a foaming step and/or a gassing step. In particular, when the creamer composition is a foaming creamer the method may comprise such a step. Suitable foaming steps and gassing steps are well known in the art. For example, the steps may comprise gassing the pre-emulsion or the emulsion concentrate e.g. at 4.0 NL/min.

For example, the method may comprise a step of cooling and/or packing the creamer composition. Suitable cooling and/or packing steps are well known in the art. For example, an after-dryer after-cooler step may be used to cool the creamer composition, and filling and closing steps may be used to pack the creamer composition.

The creamer composition obtained may be any described herein in the section above entitled “Creamer compositions”.

### Liquid Creamer Compositions

In one aspect, the present invention provides a method of producing a liquid creamer composition comprising providing a flaxseed slurry according to the present invention and sterilizing the flaxseed slurry to provide a liquid creamer composition.

Any other suitable steps may be incorporated into the method of producing a liquid creamer composition.

For example, the method may comprise a step of mixing the flaxseed slurry with water, to provide the desired amount of ground flaxseed and/or a desired viscosity. Suitably, water is added to provide a flaxseed slurry mixture comprising ground flaxseed in an amount of about 5 wt % or more, about 6 wt % or more, about 7 wt % or more, about 8 wt % or more, about 9% or more, or about 10% or more. Suitably, water is added to provide a flaxseed slurry mixture comprising ground flaxseed in an amount of about 15 wt % or less, about 14 wt % or less, about 13 wt % or less, about 12 wt % or less, about 11 wt % or less, about 10 wt % or less, or about 9 wt % or less.

For example, the method may comprise a step of mixing the flaxseed slurry with one or more further creamer ingredient, such as any ingredient described above in the section entitled “Other creamer ingredients”. In some embodiments, the flaxseed slurry mixture comprises: (a) one or more antioxidant in a total amount of about 0.05 wt % to about 1 wt % or about 0.1 wt % to about 0.5 wt %; (b) one or more cereal in a total amount of about 0.1 wt % to about 5 wt %; (c) one or more flavouring is in a total amount of about 0.1 wt % to about 5 wt %; and (d) optionally, sugar in a total amount of from about 1 wt % to about 40 wt %.

For example, the method may comprise a step of homogenizing the flaxseed slurry or flaxseed slurry mixture. Suitably, the flaxseed slurry or flaxseed slurry mixture is homogenised at about 60 °C. Suitably, the flaxseed slurry or flaxseed slurry mixture is homogenised in a two-stage homogenizer. The flaxseed slurry or flaxseed slurry mixture may be homogenised in a two-stage homogeniser at conditions with a first stage pressure between 150 bar and 250 bar and a second stage pressure being between 15% and 35% of the first stage pressure.

In some embodiments, the method of producing a liquid creamer composition comprises: (a) providing a flaxseed slurry according to the present invention; (b) mixing the flaxseed slurry with water and/or one or more further creamer ingredient; (c) homogenizing the flaxseed slurry; and (d) sterilizing the flaxseed slurry to provide a liquid creamer composition.

For example, the method may comprise a further step of cooling the liquid creamer composition and/or packing the liquid creamer composition. For example, the liquid creamer composition may be aseptically packaged in any suitable container (e.g. a bottle).

In some embodiments, the method of producing a liquid creamer composition comprises: (a) providing a flaxseed slurry according to the present invention; (b) mixing the flaxseed slurry with water and/or one or more further creamer ingredient; (c) homogenizing the flaxseed slurry; (d) sterilizing the flaxseed slurry to provide a liquid creamer composition; and (e) cooling and/or packing the liquid creamer composition.

The liquid creamer composition obtained may be any described herein in the section above entitled “Liquid creamer compositions”.

### Powder Creamer Compositions

In one aspect, the present invention provides a method of producing a powder creamer composition comprising providing a flaxseed slurry according to the present invention and drying the flaxseed slurry to provide a powder creamer composition.

Suitable drying steps are well known in the art. The drying step may be performed by spray drying, vacuum belt drying, roller drying or freeze drying. In some embodiments, the drying step is performed by spray drying. Suitable spray drying conditions are well known in the art.

Any other suitable steps may be incorporated into the method of producing a powder creamer composition.

For example, the method may comprise a step of mixing the flaxseed slurry with one or more further creamer ingredient, such as any ingredient described above in the section entitled “Other creamer ingredients”.

For example, the method may comprise a step of homogenizing the flaxseed slurry or flaxseed slurry mixture. Suitably, the flaxseed slurry or flaxseed slurry mixture is homogenised at about 50 °C to about 90 °C, for example at about 60 °C. Suitably, the flaxseed slurry or flaxseed slurry mixture is homogenised in a two-stage homogenizer for example at conditions with a first stage pressure between 150 bar and 250 bar and a second stage pressure being between 15% and 35% of the first stage pressure.

For example, the method may comprise a step of pasteurising the flaxseed slurry or flaxseed slurry mixture prior to drying. Any suitable conditions for pasteurisation may be used, for example, a pasteurizing step may be performed at a minimum temperature of 81 °C for at least 5 seconds.

In some embodiments, the method of producing a powder creamer composition comprises: (a) providing a flaxseed slurry according to the present invention; (b) mixing the flaxseed slurry one or more further creamer ingredient; (c) homogenizing the flaxseed slurry; and (d) drying the flaxseed slurry to provide a powder creamer composition.

For example, the method may comprise a further step of packing the powder creamer composition.

In some embodiments, the method of producing a powder creamer composition comprises: (a) providing a flaxseed slurry according to the present invention; (b) optionally mixing the flaxseed slurry one or more further creamer ingredient; (c) optionally homogenizing the flaxseed slurry; (d) drying the flaxseed slurry to provide a powder creamer composition; and (e) packing the powder creamer composition.

The powder creamer composition obtained may be any described herein in the section above entitled “Powder creamer compositions”.

### EXAMPLES

The invention will now be further described by way of examples, which are meant to serve to assist one of ordinary skill in the art in carrying out the invention and are not intended in any way to limit the scope of the invention.

### Example 1—Development and Evaluation of Liquid Flaxseed Creamers

Flaxseed powder produced from flaxseed was evaluated for its potential in a liquid creamer. The goal was to have a liquid flaxseed creamer with acceptable physical/chemical stability and overall sensory profile.

### Liquid Flaxseed Creamer Formulations and Processing

Roasted flaxseeds were wet milled with water at 60 °C for 7 hours to obtain a viscous paste having a low mean particle size. This was achieved using a colloidal mill. The omega-3 oils in flaxseeds were protected during the milling process with the addition of a natural antioxidant. Flaxseed particle size was measured periodically during the milling process, and milling ceased when no significant reduction in particle size was achieved. Milled flaxseeds were collected and stored at 4 °C.

Table 1 summarises liquid creamer formulations developed comprising golden roasted flaxseeds. Various flavours and antioxidants were evaluated during development.

TABLE 1
Composition of liquid flaxseed creamers

| | Creamer | | | |
|---|---|---|---|---|
| | 043 | 018 | 047 | 039 |
| | 6% | 9% | 9% | 4% |
| | flaxseed | flaxseed | flaxseed | flaxseed |
| Golden Roasted | 6 | 9 | 9 | 4 |
| Flaxseed (%) | | | | |
| Sugar (%) | 20 | 20 | 20 | 20 |
| Flavours and | 1.5 | 1.5 | 1.5 | 1.5 |
| antioxidants (%) | | | | |
| Oat Flour (%) | 0 | 0 | 1 | 2 |
| Sub-total (solids) | 27.5 | 30.5 | 31.5 | 27.5 |
| (%) | | | | |
| Water (%) | To 100% | To 100% | To 100% | To 100% |

The process steps for sample preparation included the following:
Flaxseed pastes were added to water with agitation at 20-25 °C for 15 minutes under vacuum to form a slurry.
Sugar, flavourings, and oat flour (where included) were added to the mixture with constant stirring at 20-25 °C for a further 15 minutes under vacuum.
The mixture was subsequently heated to 80 °C, followed by upstream two-stage homogenisation and then submitted to thermal UHT treatment, cooled and subjected to two-stage homogenisation at 80 °C.
The product was cooled to 50 °C, aseptically filled into bottles, and stored at 4 °C.

### Evaluation Results

Table 2 summarizes visual results for the storage study. All prototypes showed good initial physical stability. Prototypes with greater than 4 wt % flaxseed showed good physical stability over a 6-month shelf life. This indicates that greater than 4 wt % flaxseed provides the required viscosity to maintain good product stability. FIG. 1A shows that creamers 018, 043 and 047 had good stability, whereas creamer 039, comprising 4 wt % ground flaxseed, experienced marbling and phase separation defects.

TABLE 2
Visual observation recorded each month during shelf-life study

| Creamer | Initial | 1 Month | 2 Month | 3 Month | 4 Month | 5 Month | 6 Month |
|---|---|---|---|---|---|---|---|
| 043 | Good | Good | Good | Good | Good | Good | Good |
| 018 | Good | Good | Good | Good | Good | Good | Good |
| 047 | Good | Good | Good | Good | Good | Good | Good |
| 039 | Good | M | M + sSS | M + mSS | M + mSS | M + hSS | M + hSS |

M = marbling; s = slight; m = moderate; h = heavy; SS = serum separation

Table 3 shows the particle size of the creamers as measured by static light scattering

TABLE 3
Particle size as measured by static light scattering

| Creamer | D(3, 2)/μm | D90/μm |
|---|---|---|
| 018 | 6.575 | 211.945 |
| 039 | 5.324 | 199.12 |
| 043 | 6.546 | 306.495 |
| 047 | 6.068 | 255.914 |

The colour of flaxseed creamer was light to dark brown based on flaxseed content. The whiteness (L*) of flaxseed creamer was around 60 and decreased with lowering of total flaxseed. Lower flaxseed content means lower oil content which is known to be the main factor responsible for whitening effect. When added in coffee, the whiteness L* was around 40-50 and both a*, and b* values increased, suggesting increase in red and yellow colour character respectively.

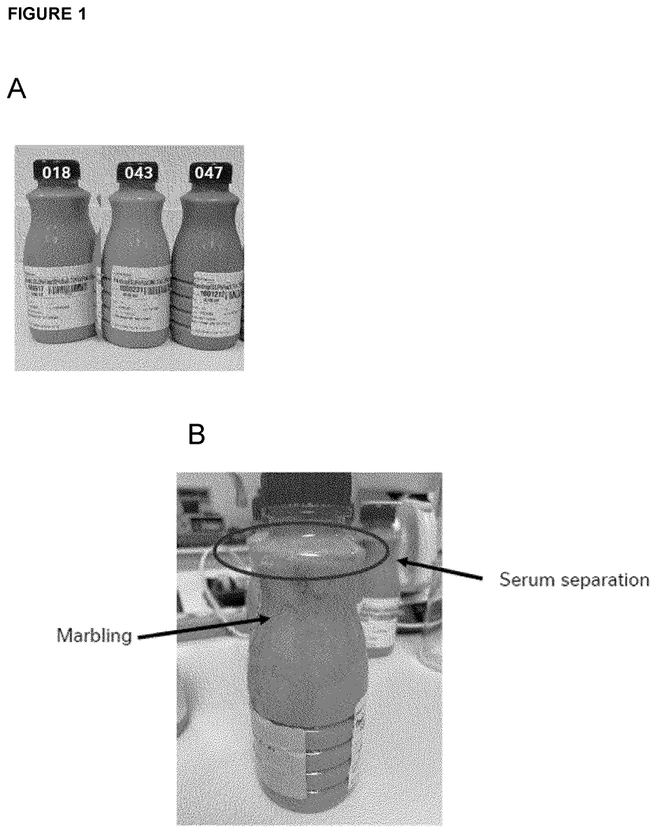

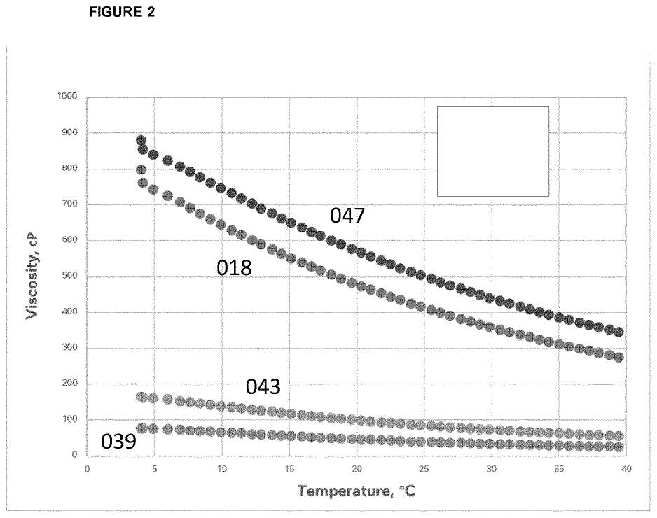

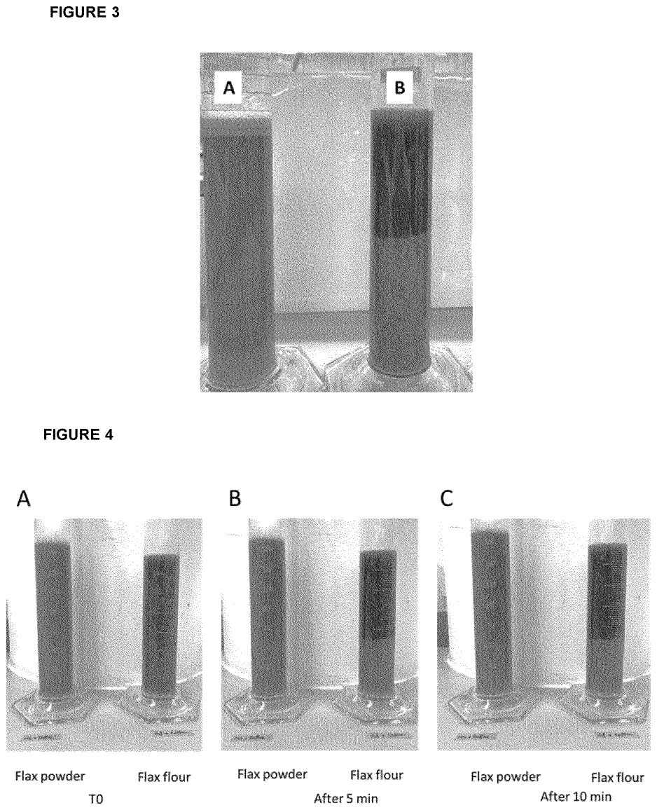

Viscosity profiles of flaxseed creamers are shown in FIG. 2. Significant increases of viscosity for prototypes 018 and 047 containing 9% flaxseeds indicated that the amount of flaxseed used in creamers was the main contribution for viscosity. Additional 1% oat flour also increased viscosity (sample 047).

### Evaluation Methods

### Visual Observation

Visual observations were performed on all samples. Bottles were pulled out of storage each month to inspect potential defects such as phase separation. Samples were poured into a beaker and examined during the pour. Products were put back into the bottles and shaken five times, and re-poured into the beaker to determine if the defects were reversible.

### Particle Characterization

The particle size characteristics were determined by static light scattering (Mastersizer 3000, Malvern Instruments Ltd., Malvern, Worcestershire, UK). Samples were diluted with dispersant (29% sugar, 0.4% dipotassium phosphate) to obtain a light scattering signal in an appropriate range for measurements.

### Flaxseed Creamer Appearance and Colour Analysis

Flaxseed creamer appearance was recorded using a digital camera, while optical properties were quantified using colorimetry (ColorFlex® EZ, HunterLab, Reston, VA). In this dual-beam spectrophotometer, a sample is illuminated by artificial daylight (400-700 nm) flashes using a xenon lamp. Creamer was poured into a transparent petri dish, and a black cup was utilized as a background. The sample was then illuminated and observed using simulated daylight conditions (D65/10). The intensity of the reflected light was measured and converted to CIE L*, a*, b* values.

### Rheology Analysis

Rheological measurements were conducted with an Anton Paar Physica MCR 501 rheometer using concentric cylinder geometries. Products were treated with the following procedure: viscosity was obtained from 4 to 40 °C, at shear rate of 75 s⁻¹ and heating rate of 2 °C/min.

### Example 2—Development and Evaluation of Powder Flaxseed Creamers

### Powder Flaxseed Creamer Formulations and Processing

Flaxseed powder produced from flaxseed was evaluated for its potential as a one-ingredient powder creamer. The goal was to have a powder flaxseed creamer with acceptable physical/chemical stability and overall sensory profile.

Roasted flaxseeds were wet milled with water at 60 °C for around 2 hours to obtain a viscous paste having a low mean particle size. This was achieved using a colloidal mill. Flaxseeds were not soaked prior to milling to decrease both viscosity and milling time. Flaxseed milling was conducted using a mixture of cellulase and xylanase to reduce the viscosity of the flaxseed slurry. Flaxseed particle size was measured periodically during the milling process, and milling ceased when no significant reduction in particle size was achieved. Milled flaxseeds were collected and stored at 4 °C. After milling the flaxseed slurry was processed into powder using spray-drying.

Comparison with Homemade Flaxseed Milk

The nutrition of flaxseed powder obtained by the process described above was compared with homemade flaxseed milk.

To obtain flaxseed milk a method described in a cook book was used: a half cup raw flaxseeds (74.86 g) and 3 cups room temperature water (~1419.63 g) were blended for 30 seconds. The contents were then poured out into a glass and left to stand for 10 mins. The foam and gel layer were discarded, and the remaining contents poured through a 1 mm sieve/cheese cloth and the filtrate (milk layer) was collected.

The nutrition profiles in Table 4 below shows that with homemade milk, most of the dietary fiber and proteins are removed. In contrast, the flaxseed powder obtained by the process described above has high amounts of flaxseed oil, flaxseed dietary fibre, and flaxseed protein.

TABLE 4
Nutrition profile of flaxseed powder and homemade flaxseed milk

| | | Homemade |
|---|---|---|
| | Flaxseed | flaxseed |
| | powder | milk |
| | Dry Weight Basis (%), | |
| Nutrition Profile | apart from Total Solids | |
| Total Solids | 7.46% | 0.23% |
| Fatty Acid Profile | | |
| Saturated Fatty Acids (Acid Form) | 3.73% | — |
| Total Cis Unsaturated Fatty Acids (Acid Form) | 37.40% | 38.3% |
| Monounsaturated Fatty Acids (Acid Form) | 6.76% | 9.1% |
| Polyunsaturated Fatty Acids (Acid Form) | 30.70% | 29.1% |
| Trans Fatty Acids (Acid Form) | <0.27% | — |
| Total Fatty Acids | 43.03% | 39.6% |
| Carbohydrates | | |
| Total Carbohydrates | 25.47% | 43.5% |
| Total Dietary Fiber | | |
| Soluble Dietary Fiber Precipitate (SDFP) | 10.72% | n.d. |
| Low Molecular Weight Soluble Dietary | <6.7% | n.d. |
| Fiber (LMWSDF) | | |
| Insoluble Dietary Fiber (IDF) | 11.41% | n.d. |
| High Molecular Weight Dietary Fiber | 22.12% | n.d. |
| (HMWDF) (IDF + SDFP) | | |
| Total Soluble Dietary Fiber (SDFP + | 10.72% | n.d. |
| LMWSDF) | | |
| Total Dietary Fiber (HMWDF + LMWSDF) | 22.12% | n.d. |
| Nitrogen Kjeldahl method | | |
| Nitrogen | 3.98% | n.d. |
| Protein | 25.47% | n.d. |
| Ash | | |
| Ash | 3.69% | n.d. |

Comparison with Flaxseed Flour

Flaxseed powder obtained by the process described above and a commercially available flaxseed flour (Glanbia Nutritionals) were separately mixed in with water at a variety of conditions and then evaluated for homogeneity of the drink and time taken for separation.

Table 5 shows the fibre composition of flaxseed powder compared to flaxseed flour.

TABLE 5
Difference in fibre composition between
flaxseed powder and flaxseed flour

| | Flaxseed | Flaxseed |
|---|---|---|
| | powder | flour |
| Soluble dietary fiber precipitate (%) | 4.07 | 7.34 |
| Low molecular weight soluble dietary fiber (%) | 3.57 | 1.23 |
| Insoluble dietary fiber (%) | 7.33 | 13.7 |
| High molecular weight dietary fiber (%) | 11.4 | 21 |
| Total soluble dietary fiber (%) | 7.64 | 8.57 |
| Total dietary fiber (%) | 15 | 22.3 |
| Ratio soluble/insoluble fiber | 1.04 | 0.62 |

Table 6 shows the total fibre and oil content of the flaxseed powder compared to flaxseed flour and homemade milk, flaxseed powder has the highest oil content by percentage of all three options, and a lower total fibre percentage than flaxseed flour.

TABLE 6
Total fibre and oil content of the flaxseed
powder v flaxseed flour v homemade milk

| | Oil | Total | Oil content/ |
|---|---|---|---|
| | content % | fibers % | Total fibers |
| Flaxseed powder | 49.8 | 15 | 3.32 |
| Flaxseed flour | 45.2 | 22 | 2.05 |
| Homemade milk | 39.6 | 0 | — |

FIGS. 3 and 4 show the visual results for the initial study on the use of flaxseed powder as a creamer. Flaxseed powder homogenised better with coffee compared to flaxseed flour and retained this initial homogenisation better over the course of 10 minutes.

Flaxseed powder had lower particle size than the flaxseed flour (see Table 7). The fibres of the flaxseed powder were smaller, helping slow sedimentation. Particle size was measured by laser light scattering. This trend continues in both the top and bottom phase of the separated phases of the homogenised drink (see Table 8). The average % of particles was always <10 μm smaller in the flaxseed powder drink than the flaxseed flour, and the oil bodies were more readily kept intact.

TABLE 7
Particle size of flaxseed powder vs flaxseed flour

| | | | | % particles | % particles | Max |
|---|---|---|---|---|---|---|
| | | | % particles | 10 < Ø < | Ø > 200 | particle |
| Samples | D90 | D(4, 3) | Ø < 10 μm | 200 μm | μm | size (μm) |
| Flaxseed flour in water | 943 | 425 | 3.15 | 34.15 | 62.7 | 1630 |
| Flaxseed powder in water | 122 | 56.3 | 16.55 | 83.45 | 0 | 211 |
| Flaxseed flour in coffee | 981 | 449 | 3.37 | 32 | 64.63 | 1850 |
| Flaxseed powder in coffee | 128 | 58.4 | 17.62 | 83.38 | 0.16 | 240 |

TABLE 8
Particle characteristics of flaxseed powder
vs flaxseed flour in coffee and water

| | | | % par- | % par- |
|---|---|---|---|---|
| | | | ticles | ticles |
| | | Dv(4, | Ø < | Ø < |
| Samples | Dv(90) | 3) | 4 μm | 10 μm |
| Flaxseed flour in water | 943 | 425 | 1.54 | 3.15 |
| Flaxseed powder in water | 122 | 56.3 | 7.38 | 16.55 |
| Flaxseed flour in water top phase | 183 | 70.4 | 14.90 | 23.61 |
| Flaxseed flour in water bottom | 960 | 454 | 1.53 | 3.03 |
| phase | | | | |
| Flaxseed powder in water top phase | 46.6 | 19.6 | 20.63 | 41.70 |
| Flaxseed powder in water bottom | 133 | 64.7 | 6.48 | 13.53 |
| phase | | | | |
| Flaxseed flour in coffee | 981 | 449 | 1.73 | 3.37 |
| Flaxseed powder in coffee | 128 | 58.4 | 7.54 | 17.62 |
| Flaxseed flour in coffee top phase | 540 | 158 | 14.48 | 20.84 |
| Flaxseed flour in coffee bottom | 962 | 446 | 1.52 | 3.17 |
| phase | | | | |
| Flaxseed powder in coffee top phase | 49.4 | 20.1 | 20.18 | 42.33 |
| Flaxseed powder in coffee bottom | 136 | 63.8 | 6.76 | 15.60 |
| phase | | | | |

Rheological measurements were conducted with a TA Instruments AR2000ex using concentric cylinder geometries. Flaxseed powder had a lower viscosity in both the homogenised and separate phases of the separate phase mixture in both coffee and water when compared to flaxseed flour (see Table 9). Thus flaxseed powder had a preferred viscosity for use as a creamer.

TABLE 9
Viscosity of drink mixture after addition
of flaxseed powder vs flaxseed flour

| | Viscosity at 40 s − 1 at |
|---|---|
| Samples | 37 °C (mPa · s) |
| Flaxseed flour in water | 11.25 |
| Flaxseed powder in water | 1.39 |
| Flaxseed flour in water top phase | 3.82 |
| Flaxseed flour in water bottom phase | 19.56 |
| Flaxseed powder in water top phase | 1.19 |
| Flaxseed powder in water bottom phase | 3.24 |
| Flaxseed flour in coffee | 12.11 |
| Flaxseed powder in coffee | 1.64 |
| Flaxseed flour in coffee top phase | 3.67 |
| Flaxseed flour in coffee bottom phase | 23.26 |
| Flaxseed powder in coffee top phase | 1.27 |
| Flaxseed powder in coffee bottom phase | 1.33 |

Table 10 shows the impact of enzymatic treatment of flaxseed slurry during the milling process led to more soluble low weight dietary fibre and less insoluble dietary fibre and high molecular weight dietary fibre.

TABLE 10
Impact of enzymatic treatment on fibre composition.

| | No enzyme | Enzyme |
|---|---|---|
| | TSav = | Tsav = |
| Analyses | 20.65% | 20.7% |
| Soluble dietary fiber precipitate (%) | 2.26 | 1.86 |
| Low molecular weight soluble dietary fiber (%) | <0.5 | 1.0 |
| Insoluble dietary fiber (%) | 2.60 | 1.82 |
| High molecular weight dietary fiber (%) | 4.86 | 3.68 |
| Total soluble dietary fiber (%) | 2.26 | 2.86 |
| Total dietary fiber (%) | 4.86 | 4.68 |

### EMBODIMENTS

Various preferred features and embodiments of the present invention will now be described with reference to the following numbered paragraphs (paras).
1. A creamer composition comprising ground flaxseed, wherein the ground flaxseed has a particle size D90 of about 800 μm or less and wherein the creamer composition comprises the ground flaxseed in an amount of about 5 wt % or more.
2. The creamer composition according to para 1, wherein the creamer composition comprises flaxseed oil in an amount of about 5 wt % or more, about 10 wt % or more, about 15 wt % or more, about 20 wt % or more, about 25 wt % or more, about 30 wt % or more, or about 35 wt % or more, on a dry weight basis.
3. The creamer composition according to para 1 or 2, wherein the creamer composition comprises flaxseed oil in an amount of about 70 wt % or less, about 65 wt % or less, about 60 wt % or less, about 55 wt % or less, or about 50 wt % or less, on a dry weight basis.
4. The creamer composition according to any preceding para, wherein the creamer composition comprises flaxseed dietary fiber in an amount of about 3 wt % or more, about 4 wt % or more, about 5 wt % or more, about 10 wt % or more, or about 15 wt % or more, on a dry weight basis.
5. The creamer composition according to any preceding para, wherein the creamer composition comprises flaxseed dietary fiber in an amount of about 50 wt % or less, about 45 wt % or less, about 40 wt % or less, about 35 wt % or less, about 30 wt % or less, about 25 wt % or less, or about 20 wt % or less, on a dry weight basis.
6. The creamer composition according to any preceding para, wherein the creamer composition comprises flaxseed protein in an amount of about 3 wt % or more, about 4 wt % or more, about 5 wt % or more, about 10 wt % or more, or about 15 wt % or more, on a dry weight basis.
7. The creamer composition according to any preceding para, wherein the creamer composition comprises flaxseed protein in an amount of about 50 wt % or less, about 45 wt % or less, about 40 wt % or less, about 35 wt % or less, about 30 wt % or less, about 25 wt % or less, or about 20 wt % or less, on a dry weight basis.
8. The creamer composition according to any preceding para, wherein the creamer composition has a weight ratio of flaxseed oil/flaxseed dietary fibers of about 1.5 or more, about 2.0 or more, about 2.5 or more, or about 3.0 or more.
9. The creamer composition according to any preceding para, wherein the creamer composition comprises about 13.0 wt % or less, about 12.0 wt % or less, about 11.0 wt % or less, about 10.0 wt % or less, about 9.0 wt % or less, or about 8.0 wt % or less insoluble dietary fiber, on a dry weight basis.
10. The creamer composition according to any preceding para, wherein the creamer composition comprises about 1.0 wt % or more, about 1.5 wt % or more, about 2.0 wt % or more, 2.5 wt % or more, 3.0 wt % or more, or 3.5 wt % or more low molecular weight soluble dietary fiber, on a dry weight basis.
11. The creamer composition according to any preceding para, wherein the creamer composition comprises about 22.0 wt % or less, about 20.0 wt % or less, about 18.0 wt % or less, about 16.0 wt % or less, about 14.0 wt % or less, or about 12.0 wt % or less high molecular weight soluble dietary fiber, on a dry weight basis.
12. The creamer composition according to any preceding para, wherein the creamer composition has a weight ratio of soluble dietary fiber/insoluble dietary fiber of about 0.7 or more, about 0.8 or more, about 0.9 or more, or about 1.0 or more.
13. The creamer composition according to any preceding para, wherein the ground flaxseed is wet-milled, preferably wherein the ground flaxseed is colloid-milled.
14. The creamer composition according to any preceding para, wherein the ground flaxseed has a particle size D90 of about 700 μm or less.
15. The creamer composition according to any preceding para, wherein the ground flaxseed has a particle size D90 of about 600 μm or less, or about 500 μm or less.
16. The creamer composition according to any preceding para, wherein the ground flaxseed has a particle size D(3,2) of about 20 μm or less, about 15 μm or less, about 10 μm or less, about 9 μm or less, about 8 μm or less, about 7 μm or less, about 6 μm or less, or about 5 μm or less.
17. The creamer composition according to any preceding para, wherein the flaxseed is a golden variety, optionally wherein the flaxseed is a NuLin variety or an Omega variety.
18. The creamer composition according to any preceding para, wherein the flaxseed is dehulled.
19. The creamer composition according to any preceding para, wherein the flaxseed is roasted.
20. The creamer composition according to any preceding para, wherein the flaxseed is enzymatically treated, optionally wherein the flaxseed is enzymatically treated with cellulase and/or xylanase.
21. The creamer composition according to any preceding para, wherein the creamer composition does not comprise any added emulsifier.
22. The creamer composition according to any preceding para, wherein the creamer composition does not comprise any added buffering agent.
23. The creamer composition according to any preceding para, wherein the creamer composition does not comprise any added hydrocolloid.
24. The creamer composition according to any preceding para, wherein the creamer composition further comprises one or more antioxidant, optionally wherein the creamer composition further comprises rosemary and tocopherol.
25. The creamer composition according to any preceding para, wherein the creamer composition further comprises one or more cereal, optionally wherein the creamer composition further comprises oat flour.
26. The creamer composition according to any preceding para, wherein the creamer composition further comprises one or more flavouring.
27. The creamer composition according to any preceding para, wherein the creamer composition further comprises sugar.
28. The creamer composition according to any preceding para, wherein the creamer composition does not comprise added sugar.
29. The creamer composition according to any of paras 1 to 28, wherein the creamer composition is a liquid creamer.
30. The creamer composition according to para 29, wherein the creamer composition comprises the ground flaxseed in an amount of about 6 wt % or more, about 7 wt % or more, or about 8 wt % or more.
31. The creamer composition according to para 29 or 30, wherein the creamer composition comprises the ground flaxseed in an amount of about 10 wt % or less, or about 9 wt % or less.
32. The creamer composition according to any of paras 29 to 31, wherein the creamer composition comprises the ground flaxseed in an amount of from about 5 wt % to about 7 wt %, preferably wherein the creamer composition comprises the ground flaxseed in an amount of about 6 wt %.
33. The creamer composition according to any of paras 29 to 32, wherein the creamer composition has a viscosity of about 100 cP or more, about 150 cP or more, about 160 cP or more, or about 170 cP or more, at 4 °C and a shear rate of 75 s⁻¹.
34. The creamer composition according to any of paras 29 to 33, wherein the creamer composition comprises one or more antioxidant in a total amount of about 0.05 wt % to about 1 wt %, or about 0.1 wt % to about 0.5 wt %.
35. The creamer composition according to any of paras 29 to 34, wherein the creamer composition comprises one or more cereal in a total amount of about 0.1 wt % to about 5 wt %.
36. The creamer composition according to any of paras 29 to 35, wherein the creamer composition comprises one or more flavouring is in a total amount of about 0.1 wt % to about 5 wt %.
37. The creamer composition according to any of paras 29 to 36, wherein the creamer composition comprises sugar in a total amount of from about 1 wt % to about 40 wt %.
38. The creamer composition according to any of paras 1 to 28, wherein the creamer composition is a powder creamer.
39. The creamer composition according to para 38, wherein the creamer composition is spray-dried.
40. The creamer composition according to para 39, wherein the creamer composition comprises the ground flaxseed in an amount of about 20 wt % or more, about 25 wt % or more, about 30 wt % or more, or about 35 wt % or more, prior to spray-drying.
41. The creamer composition according to any preceding para, wherein the creamer composition is a vegan creamer.
42. The creamer composition according to any preceding para, wherein the creamer composition is a beverage creamer, preferably a coffee creamer, a tea creamer or a cocoa creamer.
43. A beverage capsule comprising the creamer composition according to any of paras 1 to 42.
44. A beverage system comprising the creamer composition according to any of paras 1 to 42.
45. A beverage composition comprising the creamer composition according to any one of any of paras 1 to 42, optionally wherein the beverage composition is a coffee, tea, or cocoa beverage.
46. The beverage composition of para 45, wherein the beverage composition is a coffee mix, for example comprising a soluble coffee, the creamer composition according to any one of any of paras 1 to 42, optionally sugar, and optionally a foaming agent.
47. A method of preparing a beverage composition, comprising:
   (a) providing a beverage composition base; and
   (b) adding the creamer composition according to any of paras 1 to 42 to the beverage composition base.
48. A method of producing a flaxseed slurry for use in a creamer composition, the method comprising:
   (a) providing whole or dehulled flaxseed; and
   (b) wet-milling the flaxseed to provide a flaxseed slurry comprising ground flaxseed having a particle size D90 of about 800 μm or less.
49. The method according to para 48, wherein the flaxseed is a golden variety, optionally wherein the flaxseed is a NuLin variety or an Omega variety.
50. The method according to para 48 or 49, wherein the flaxseed is dehulled.
51. The method according to any of paras 48 to 50, wherein the flaxseed is roasted.
52. The method according to any of paras 48 to 51, wherein the method further comprises a step of enzymatic treatment prior to, during and/or after wet-milling.
53. The method according to para 52, wherein the enzymatic treatment comprises treatment with cellulase and/or xylanase.
54. The method according to any of paras 42 to 53, wherein the flaxseed is wet-milled in a colloid mill.
55. The method according to any of paras 42 to 54, wherein the flaxseed is milled to a particle size D90 of about 700 μm or less.
56. The method according to any of paras 42 to 55, wherein the flaxseed is milled to a particle size D90 of about 600 μm or less, or about 500 μm or less.
57. The method according to any of paras 42 to 56, wherein the flaxseed is milled to a particle size D(3,2) of about 20 μm or less, about 15 μm or less, about 10 μm or less, about 9 μm or less, about 8 μm or less, about 7 μm or less, about 6 μm or less, or about 5 μm or less.
58. The method according to any of paras 42 to 57, wherein the flaxseed slurry is homogenised after the wet-milling, for example in a two-step homogenizer, for example with a first stage pressure between 150 bar and 250 bar and a second stage pressure between 15% and 35% of the first stage pressure.
59. The method according to para 58, wherein the flaxseed slurry is homogenised at about 50 °C to about 90 °C, for example at about 60 °C.
60. The method according to any of paras 42 to 59, wherein water is added to the flaxseed slurry after wet-milling and/or homogenisation, to provide a flaxseed slurry comprising the ground flaxseed in an amount of about 5 wt % or more, of about 6 wt % or more, about 7 wt % or more, or about 8 wt % or more.
61. The method according to any of paras 42 to 60, wherein water is added to the flaxseed slurry after wet-milling and/or homogenisation, to provide a flaxseed slurry comprising the ground flaxseed in an amount of about 14 wt % or less, about 13 wt % or less, about 12 wt % or less, about 11 wt % or less, about 10 wt % or less, or about 9 wt % or less.
62. A flaxseed slurry for use in a creamer composition, wherein the flaxseed slurry is obtained or obtainable by the method according to any of paras 42 to 61.
63. A flaxseed slurry for use in a creamer composition, wherein the flaxseed slurry comprises ground flaxseed having a particle size D90 of about 800 μm or less.
64. The flaxseed slurry according to para 63, wherein the ground flaxseed is wet-milled, preferably wherein the ground flaxseed is colloid-milled.
65. The flaxseed slurry according to para 63 or 64, wherein the ground flaxseed has a particle size D90 of about 700 μm.
66. The flaxseed slurry according to any of paras 63 to 65, wherein the ground flaxseed has a particle size D90 of about 600 μm or less, or about 500 μm or less.
67. The flaxseed slurry according to any of paras 63 to 66, wherein the ground flaxseed has a particle size D(3,2) of about 20 μm or less, about 15 μm or less, about 10 μm or less, about 9 μm or less, about 8 μm or less, about 7 μm or less, about 6 μm or less, or about 5 μm or less.
68. The flaxseed slurry according to any of paras 63 to 67, wherein the flaxseed slurry comprises the ground flaxseed in an amount of about 5 wt % or more, of about 6 wt % or more, about 7 wt % or more, or about 8 wt % or more.
69. The flaxseed slurry according to any of paras 63 to 68, wherein the flaxseed slurry comprises the ground flaxseed in an amount of about 14 wt % or less, about 13 wt % or less, about 12 wt % or less, about 11 wt % or less, about 10 wt % or less, or about 9 wt % or less.
70. The flaxseed slurry according to any of paras 63 to 69, wherein the flaxseed is a golden variety, optionally wherein the flaxseed is a NuLin variety or an Omega variety.
71. The flaxseed slurry according to any of paras 63 to 70, wherein the flaxseed is dehulled.
72. The flaxseed slurry according to any of paras 63 to 71, wherein the flaxseed is roasted.
73. The flaxseed slurry according to any of paras 63 to 72, wherein the flaxseed is enzymatically treated, optionally wherein the flaxseed is enzymatically treated with cellulase and/or xylanase.
74. A method of producing a liquid creamer composition comprising:
   (a) providing a flaxseed slurry according to any of paras 62 to 73;
   (b) optionally mixing the flaxseed slurry with water and/or one or more further creamer ingredient;
   (c) optionally homogenizing the flaxseed slurry; and
   (d) sterilizing the flaxseed slurry to provide a liquid creamer composition.
75. The method according to para 74, wherein the method comprises a further step of cooling the creamer composition and/or packing the creamer composition.
76. The method according to para 74 or 75, wherein the liquid creamer composition is defined according to any of paras 29 to 37.
77. A method of producing a powder creamer composition comprising:
   (a) providing a flaxseed slurry according to any of paras 62 to 73;
   (b) optionally mixing the flaxseed slurry one or more further creamer ingredient;
   (c) optionally homogenizing the flaxseed slurry; and
   (d) drying the flaxseed slurry to provide a powder creamer composition.
78. The method according to para 77, wherein the method comprises a further step of pasteurising the flaxseed slurry prior to drying.
79. The method according to para 77 or 78, wherein the drying step is spray-drying.
80. The method according to any of paras 77 to 79, wherein the method comprises a further step of packing the creamer composition.
81. The method according to any of paras 77 to 80, wherein the powder creamer composition is defined according to any of paras 38 to 40.
82. Use of a flaxseed slurry according to any of paras 62 to 73 in a creamer composition, preferably a beverage creamer composition, such as a coffee creamer, a tea creamer or a cocoa creamer.

1. A creamer composition comprising ground flaxseed, wherein the ground flaxseed has a particle size D90 of about 800 μm or less and wherein the creamer composition comprises the ground flaxseed in an amount of about 5 wt % or more.

2. The creamer composition according to claim 1, wherein the creamer composition comprises, on a dry weight basis:
(a) flaxseed oil in an amount of about 5 wt % or more;
(b) flaxseed dietary fiber in an amount of about 3 wt % or more; and
(c) flaxseed protein in an amount of about 3 wt % or more.

3. The creamer composition according to claim 1, wherein the ground flaxseed has:
(a) a particle size D90 of about 700 μm or less; and/or
(b) a particle size D(3,2) of about 20 μm or less.

4. The creamer composition according to claim 1, wherein the ground flaxseed is dehulled, roasted, and/or enzymatically treated with cellulase and/or xylanase.

5. The creamer composition according to claim 1, wherein the creamer composition does not comprise any added emulsifier, any added buffering agent, and/or any added hydrocolloid.

6. The creamer composition according to claim 1, wherein the creamer composition is a liquid creamer.

7. The creamer composition according to claim 1, wherein the creamer composition is a powder creamer.

8. The creamer composition according to claim 1, wherein the creamer composition is a beverage creamer.

9. A beverage capsule, beverage system, or beverage composition comprising the creamer composition according to claim 1.

10. A method of preparing a beverage composition, the method comprising:
(i) providing a beverage composition base; and
(ii) adding the creamer composition according to claim 1 to the beverage composition base.

11. A method of producing a flaxseed slurry for use in a creamer composition, the method comprising:
(a) providing whole or dehulled flaxseed; and
(b) wet-milling the whole or dehulled flaxseed to provide the flaxseed slurry, the flaxseed slurry comprising ground flaxseed having a particle size D90 of about 800 μm or less.

12. (canceled)

13. A method of producing a liquid creamer composition, the method comprising:
(a) providing a flaxseed slurry comprising ground flaxseed, wherein the ground flaxseed has a particle size D90 of about 800 μm or less;
(b) optionally mixing the flaxseed slurry with water and/or one or more further creamer ingredient;
(c) optionally homogenizing the flaxseed slurry; and
(d) sterilizing the flaxseed slurry to provide the liquid creamer composition.

14. A method of producing a powder creamer composition, the method comprising:
(a) providing the flaxseed slurry according to claim 12;
(b) optionally mixing the flaxseed slurry one or more further creamer ingredient;
(c) optionally homogenizing the flaxseed slurry; and
(d) drying the flaxseed slurry to provide the powder creamer composition.

15. (canceled)

16. The creamer composition according to claim 5, wherein the creamer composition further comprises: one or more antioxidant; one or more cereal; one or more flavouring; and/or sugar.

17. The creamer composition according to claim 8, wherein the beverage creamer is a coffee creamer, a tea creamer or a cocoa creamer.
